(19) United States
(12) Patent Application Publication
(10) Pub. No.: US 2003/0215934 A1
(43) Pub. Date: Nov. 20, 2003

(54) System for reproducing and dispensing bio-cultures for bio-augmentation

(76) Inventor: Thomas S. Rothweiler, Phoenix, AZ (US)

Correspondence Address: Thomas S. Rothweiler, 4331 East Western Star Blvd., Phoenix, AZ, 85044-1007, US

(21) Appl. No.: 10/463,746

(22) Filed: Jun. 16, 2003

Related U.S. Application Data
(63) Continuation-in-part of application No. 09/234,153, filed on Jan. 19, 1999, now Pat. No. 6,579,712.

(51) Int. Cl. C12S 1/00; B09B 3/00; C02F 3/02

(52) U.S. Cl. 435/262.5; 210/620

(57) ABSTRACT

A system for reproducing and dispensing bio-cultures for bio-augmentation. The system comprises a bacteria solution bio-reactor tank, and an aeration pump coupled to the bacteria solution bio-reactor tank further comprising an in-line biological filter. A waste-digesting bacteria additive is placed into the bacteria solution bio-reactor tank. The waste-digesting bacteria produced within the bacteria solution bio-reactor tank is used to treat wastes and waste byproducts. The growth of the waste-digesting bacteria is enhanced by the addition of a controlled heating source coupled to the bacteria solution bio-reactor tank and an optional re-circulation pump coupled to the bacteria solution bio-reactor tank.

### RELATED APPLICATION

This application is a Continuation-In-Part application of U.S. Ser. No. 09/234,153, filed in the United States Patent Office on Jan. 19, 1999 entitled “SYSTEM FOR REPRODUCING AND DISPENSING BIO-CULTURES FOR BIO-AUGMENTATION AND METHOD THEREFOR” the disclosure of which is hereby incorporated into this patent application by reference thereto.

### BACKGROUND OF THE INVENTION

1. Field of the Invention

This invention is in the field of waste treatment systems, and more particularly, is a system for bio-cultural reproduction and a system of growing and applying super concentrated bio-cultures, including enzymes and bacteria, to waste and waste byproducts to accelerate their breakdown, reduce the toxicity thereof, and/or enhance bio-gas production.

2. Description of the Related Art

In nature, microbial or bacterial action in organic waste products takes place at a constant rate varying chiefly due to temperature and moisture. The microbial action spoken of here is produced by, without being limited to, bacteria, enzymes, and other grown bio-cultures or chemicals. In manmade waste sites, the microbial action is also dependent on the local environmental conditions present, temperature and moisture, in and around the waste materials. The operators of most manmade waste sites desire an accelerated microbial action however in order to reduce decomposition time, reduce toxic effects etc. Therefore, in order to accelerate the microbial action in manmade waste sites, most operators use a bio-remediation, or bio-augmentation, program. Bio-augmentation is the addition of concentrated bacteria or enzymes targeted toward a specific waste, accelerating the natural breakdown of the waste. By formulating a balanced mixture of bacteria in proper ratio for a particular application, an improvement over nature occurs. Since much of the waste today contains elements that the indigenous bacteria in a given system are not capable of degrading, even when invigorated with the addition of probiotic nutrients, a bio-augmentation program is utilized. In addition to much faster degradation, the selected bio-cultures can also retard the production of many of the gasses produced by the process of decomposition. Hydrogen sulfide and ammonia, both of which can be deadly in high concentrations, are major sources of odor. Both of these byproducts can be reduced through bio-augmentation with specific bio-cultures. Additionally, some bio-cultures can even optimize the production of other byproducts, such as methane and hydrogen, should a bio-gas recovery program be desirable.

Most bio-remediation programs rely on periodic additions of bio-cultures which enhance the microbial action in the waste. Typical programs call for these bio-culture additions from once a day to once a month or longer. However, the bio-remediation programs currently available have problems and drawbacks. Bio-remediation programs that rely solely on manual systems for the addition of the bio-cultures, may find the optimum level of microbial action in the treated waste target very difficult to achieve. This is because the reliance on memory and physical labor to add the necessary bio-cultures often lead to failures to add either enough of the desired bio-cultures, or to add the bio-cultures frequently enough to maintain an optimum level of microbial action. Additionally, most bio-cultures today come in a form that has a limited shelf life, and/or is not at an optimum strength or characteristic due to non-ideal shipping and storage conditions thus making manual bio-culture additions a problematic addition method. Yet a further problem is in bio-culture additions is having a sufficient quantity of the bio-culture on hand at the target site.

Therefore a need existed for a system for growing bio-cultures having optimized strengths and characteristics where the system addresses some or all of the above identified problems.

### SUMMARY OF THE INVENTION

According to a preferred embodiment, a system for reproducing and dispensing bio-cultures for bio-augmentation is disclosed. The system for reproducing and dispensing bio-cultures for bio-augmentation comprises: a bio-reactor tank, waste-digesting bio-culture additive placed into the bio-reactor tank, nutrient additive placed into the bio-reactor tank, a metering pump coupled to the bio-reactor tank, an aeration pump coupled to the bio-reactor tank, and a control system coupled to the metering pump and coupled to the aeration pump. The system for reproducing and dispensing bio-cultures for bio-augmentation further comprises a bio-culture contact tank coupled to the bio-reactor tank, a controlled heating element coupled to the bio-reactor tank, a re-circulation pump coupled to the bio-reactor tank, a mixing valve coupled to the bio-culture contact tank, to the bio-reactor tank, and to the re-circulation pump, an in-line biological filter coupled to the aeration pump, and a biological substrate situate within the bio-reactor tank.

In addition, this invention provides, in accordance with another embodiment thereof, a system for reproducing and dispensing bio-cultures for bio-augmentation, comprising: a bio-reactor tank, a biological substrate situate within the bio-reactor tank, an aeration pump coupled to the bio-reactor tank, and an in-line biological filter coupled to the aeration pump. The invention further provides such a system comprising a controlled heating element coupled to the bio-reactor tank, a re-circulation pump coupled to the bio-reactor tank, a waste-digesting bio-culture additive placed into the bio-reactor tank, a nutrient additive placed into the bio-reactor tank, a spigot coupled to the bio-reactor tank, and a metering pump coupled to the bio-reactor tank.

Furthermore, this invention provides, in accordance with another embodiment thereof, a system for reproducing and dispensing bio-cultures for bio-augmentation, comprising: a bio-reactor tank, waste-digesting bio-culture additive placed into the bio-reactor tank, nutrient additive placed into the bio-reactor tank, and an aeration pump coupled to the bio-reactor tank. The invention further provides such a system comprising: a heating element coupled to the bio-reactor tank, a re-circulation pump coupled to the bio-reactor tank, an in-line biological filter coupled to the aeration pump, a biological substrate situate within the bio-reactor tank, and a means for dispensing coupled to the bio-reactor tank.

The foregoing and other objects, features, and advantages of the invention will be apparent from the following, more particular, description of the preferred embodiments of the invention, as shown in the accompanying drawings.

### BRIEF DESCRIPTION OF THE DRAWING

FIG. 1 is a simplified functional diagram of the present invention, a system for reproducing and dispensing bio-cultures for bio-augmentation.

FIG. 2 is a simplified functional diagram of an alternate embodiment of the present invention, a system for reproducing and dispensing bio-cultures for bio-augmentation.

FIG. 3a illustrates an arrangement of biological substrate media placed within the bio-reactor tank, as would be viewed from a overhead position, in an embodiment of the present invention.

FIG. 3b illustrates an alternate arrangement of biological substrate media placed within the bio-reactor tank, as would be viewed from a overhead position, in an alternate embodiment of the present invention.

FIG. 3c illustrates another alternate arrangement of biological substrate media placed within the bio-reactor tank, as would be viewed from a overhead position, in additional alternate embodiment of the present invention.

### DESCRIPTION OF THE PREFERRED EMBODIMENTS

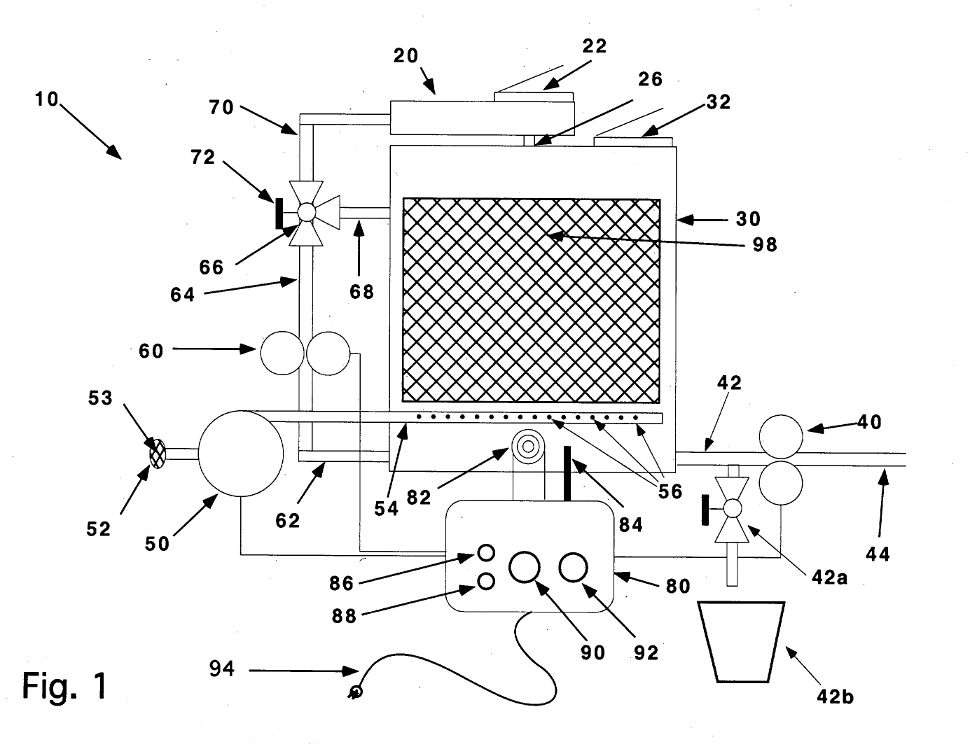

With reference to all the Figures, features of the preferred embodiments are explained below. Referring to FIG. 1, a simplified block diagram of a preferred embodiment of the present invention, a system for reproducing and dispensing bio-cultures for bio-augmentation (“the system 10” hereinafter) is shown. The system 10, in a preferred embodiment, of the present invention, comprises, a bio-augmentation system 10 (the “system 10” hereinafter.) The system 10 is an apparatus that grows a concentrated solution of bio-culture for addition into a designated, or target, wastestream or waste collection system.

The system 10 is comprised of a variety of components whose designed objective is the controlled growth of desired bio-cultures and the controlled and accurate delivery thereof into targeted waste or waste systems. The controlled growth of the present invention is capable of achieving microbial count increases of up to a 1000 fold or more. Referring again to FIG. 1, a bio-reactor tank 30 is shown. The bio-reactor tank 30 contains the bio-culture both for controlled growth and storage of bio-cultures, and provides a source system for the dispensing of the bio-culture into waste and waste systems. Coupled to the bio-reactor tank 30 is a contact tank 20 into which concentrated bio-cultures, or bio-culture starter concentrates may be placed, either in dry or liquid form. The concentrated bio-cultures are added via an addition opening 22. In the event that less concentrated bio-cultures, in dry or liquid form, are desired to be added to the system 10, they may be added via the fill opening 32. It should be noted that some embodiments of the present invention may not comprise a contact tank 20 in which case all additions occur via the fill opening 32 of the bio-reactor tank 30. Additionally, if other liquid or fluids are required to be added to the system 10 to provide replacement fluids or for other purposes, they may also be added via the fill opening 32. When a contact tank is utilized, its contents are added into the larger bio-reactor tank 30 via the coupling 26.

Examples of the applications in which the present invention may be used, though not limited to such examples, are listed below in table 1.

TABLE 1
Exemplary Usage Of Bio-Culture Growth and Additions.

| General Category | Category Examples |
|---|---|
| Pit Latrines | Pit Latrines, Outdoor Toilets, Composting Toilets. |
| Septic Tank Systems | Cesspools, Septic Tanks. |
| Holding Tanks | Portable Toilets, RV and Boat Holding Tanks. |
| Wastewater Treatment Plants | Municipal, Industrial, Package Plants, Imhof Tanks. |
| Grease Traps in Food Processing | Restaurant Grease Traps, Industrial and Protein |
| | Processing. |
| Pretreatment | Any Site that Discharges Pollutants to Waters, |
| | Separators. |
| Intensive Livestock Production | Herbaceous Livestock Production such as Swine, |
| | Cattle, Sheep, Dairy, etc. |
| Aguaculture | Non-Recirculating Aquaculture and Mariculture |
| Surface Water Remediation | Effluent and Non-Effluent Dominated Streams, Open |
| | Sewers. |
| Closed Aquatic, Horticultural or | Hydroponics, Closed Aquaculture. |
| Agricultural Systems | |
| Recirculating Systems Re-mediating | Industrial, HVAC, Hazardous Waste. |
| Waste | |
| Extra-Planetary Environments | Lunar and Planetary Environments, Near-Earth Orbit |
| | Platforms and Interplanetary Vehicles. |
| Cleaning-in-Place | Comprises CIP in dairy, wineries, breweries, drip |
| | irrigation systems. |
| Biogas Generation | Anaerobic Digesters that Produce Commercial Biogas |
| | (Methane, Hydrogen, etc.) and Chemicals (Alcohols, |
| | etc.) |
| Petroleum Hydrocarbon | Oil spill locations, car & truck-wash water recovery |
| Contamination sites | systems, industrial oil re-processing / disposal sites. |

The bio-cultures comprise aerobic, anaerobic, and facultative bacteria and/or enzymes. The bio-cultures achieve the bio-conversion of organic compounds into elemental compounds, various gasses, fatty acids and water through both catabolic and metabolic enzyme digestion, under both aerobic and anaerobic conditions in order to either accelerate, or inhibit the microbial activity of the waste, and waste byproducts. Additionally, yet another feature of the present invention is to enable the rapid breakdown of specific wastes for the production of bio-gas, specifically methane and hydrogen. The production and utilization of bio-gas can positively benefit the earth's environmental conditions by the replacement of fossil fuels, and recovery of methane, both factors that otherwise contribute to global warming. The present invention can make bio-gas economically feasible, and due to continued injections/applications of methane producing bacteria into anaerobic digesters, the anaerobic conditions necessary for methane production are more easily maintained.

Many different products for the growth of bio-cultures are available on the market which are designed for this purpose. For example, bio-cultures may include, without being limited to, products such as AquaKlenz, SaniKlenz, PetroKlenz and NitroKlenz produced by Aqualogy BioRemedics, a division of Rothweiler Corporation, incorporated in and doing business in Phoenix, Ariz.; (http://www.aqualogy.com); and Microbe-Lift available from Ecological Laboratories, Inc. of Freeport, N.Y. It will be understood by those skilled in the art that the terms: bio-culture, bacteria, enzymes, etc. may be used interchangeably herein, and the usage will be understood by those skilled in the art. Additionally, these products are typified by not only featuring bacteria, microorganisms, or enzymes, but by also specifically including nutrients to enhance the growth of the bio-cultures. The bio-cultures, as is also explained later, added to the system 10 of the present invention, may be in either dry or liquid form.

Generally, the microorganisms of these bio-cultures have been cultivated in laboratories, mostly throughout the industrial world. One of the largest collections is from the American Type Culture Collection (ATCC). An additional feature of the present invention is that because it may be desirable to avoid introducing exotic sub-species of microorganisms into a particular environment, the present invention has the capability of reproducing and growing indigenous microorganisms, or bio-cultures, wherever the invention is to be used, without the importation of specific “American” sub-species of microorganisms, or bio-culture. This feature may be achieved by placing various organic materials containing a variety of indigenous microorganisms within the system 10 where they may be cultured. An illustrative example, in an embodiment of the present invention comprises the following: Because the system 10 produces large quantities of waste-digesting microorganisms in the bio-culture from small amounts of selected microorganisms, a typical starter amount can be one ounce of a blend of spoor-form or live, vegetative microorganisms. Although, it should be noted that a smaller or greater amount of the blend of spoor-form or live, vegetative microorganisms may be used in the system 10 as needs dictate. In addition to the blend of spoor-form or live, vegetative microorganisms, 4-ounces or more of specific nutrient materials are also placed into the system 10. These items are mixed into water inside the bio-reactor tank 30, or into the contact tank 20, and with proper environmental conditions over a period of time, usually between 3 and 21 days, large quantities of microorganisms are produced and reared. It has been found in some embodiments that some of the highest growth periods of microorganisms occurs between 3 and 7 days. These can then be dispensed into a wastestream, for rapid and thorough biological treatment.

An additional feature of the present invention is that conditioning of the microorganisms to have greater waste-reducing capabilities against a specific targeted waste, may be accomplished by adding samples of the targeted waste to the system 10, during the reproductive process. The bio-cultures that will be grown and dispensed from a preferred embodiment of the present invention, digest sludge, and inhibit undesirable by-products and malodor.

Referring again to FIG. 1, the base stock, or seed bio-cultures are also replenished in the bio-reactor tank 30 on a periodic basis in order to maintain sufficient bio-reactor tank 30 quantity levels, and to achieve the then desired mix of specific bio-cultures. A further addition, or as part of the bio-culture source stock, is the addition of nutrients. The addition of nutrients to, or as part of, the bio-cultures is an important part of bio-culture growth.

The bio-cultures introduced into the bio-reactor tank 30 will be replicated by the system 10 using support systems coupled to the bio-reactor tank 30 to achieve an ideal growth environment for the bio-cultures. This ideal growth environment will result in the bio-culture forming an ultra-concentrated biological solution possessing very high Colony Forming Units (CFUs). The periodic addition of this ultra-concentrated biological solution to a wastestream or system has the advantage of counteracting any toxins that can get into the waste systems that might destroy beneficial bacteria, thus causing a reduction in treatment capability of the unaided waste system. Additionally, the ultra-concentrated biological solution allows far larger numbers of the beneficial and desired bacteria of the bio-culture to be applied to the waste than could otherwise be applied.

When the ultra-concentrated bio-cultures are placed into an aqueous wastewater system they can soon become the dominant organisms in the system, and bio-convert the organic contaminants into fractions of smaller molecular weight. Ultimately, many compounds will be completely metabolized by the bio-culture microbes and result in a source of carbon useful for cell growth.

The bio-cultures from the system 10 break the chemical structure from complex forms to simple forms: fatty acids, carbon dioxide and water. The microbes grown within the bio-generator tank 30, and within the wastestream, have an absolute rate of biodegradation of the contaminant. This rate of biodegradation can be accelerated by using multiple inoculations.

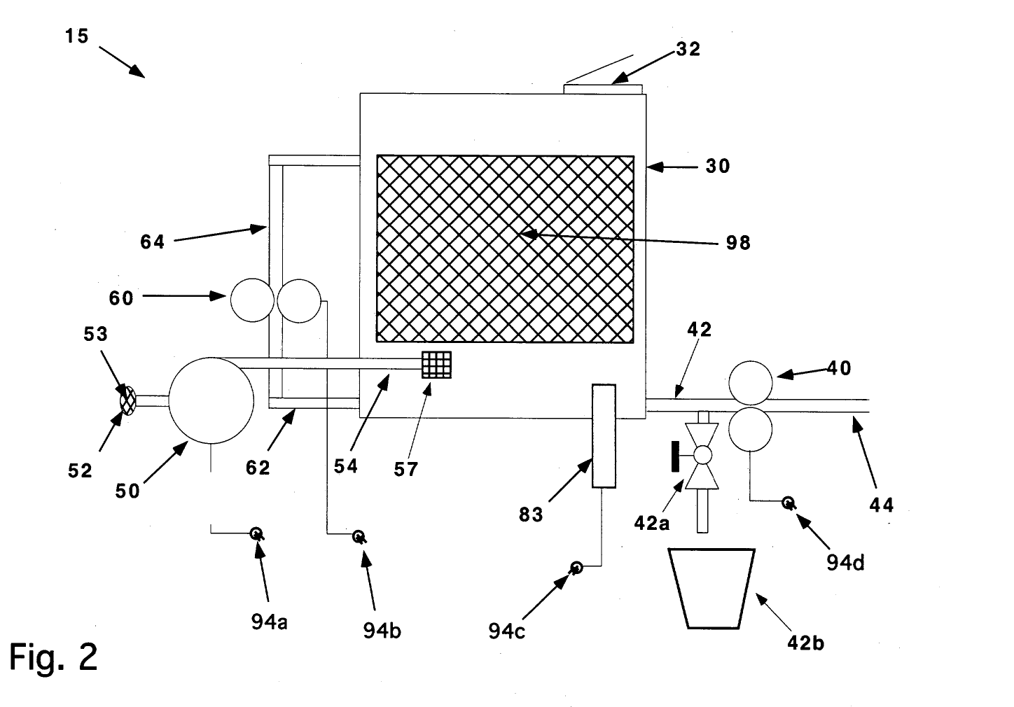

The ideal growth environment is achieved by the enhancement of the internal conditions of the bio-reactor tank 30. Coupled to the bio-reactor tank 30 is an aerator pump 50. The aerator pump 50 takes a suction on the atmosphere via a suction 52, and pumps air into the bio-reactor tank 30. A 0.2 μ [micron] in-line biological filter 53 is used to prevent airborne bacteria from entering the bio-reactor tank 30 and is a feature of the present invention. The air is pumped into the bio-reactor tank 30 via the air manifold 54, and bubbles into the bio-culture through the air holes 56. The addition of the air is used to oxygenate the bio-culture within the bio-reactor tank 30, in order to invigorate and enhance the reproduction of the bio-culture. The air pump 50 is controlled by the aerator control 86, on the control unit 80, although in the event that continuous operation of the air pump 50 is desired, it could be coupled directly to a power source as is depicted in FIG. 2. The control unit 80, and the components, or systems, coupled thereto, are provided with electrical power via a standard 120 VAC-plug 94 coupled to the control unit 80. It should be noted however, that in an alternate embodiment of the system 10, different, or higher voltage sources, or even unconventional electrical sources such as solar cell panels, e.g. in an outhouse application in a remote forest location, might be used to power an embodiment of the system 10. The system 10 also comprises a heater 82 to add heat to the bio-culture. Heat is one of the primary elements of microbial growth. This heat can be comprised of many different types, or sources, from the electromagnetic spectrum. For example: Electromagnetic growth accelerators may comprise: audible sound, ultrasound; magnetic energy; low level radiation; and photogenic accelerators, such as growing lights of optimal spectral qualities are some of the “heat” sources, or heaters, that might be utilized in an alternate embodiment of the present invention.

The heater 82 is controlled by the control unit 80. A temperature sensing unit 84, coupled to the bio-reactor tank 30, senses the internal temperature of the bio-reactor tank 30 and in combination with the temperature thermostat 90 adjusts the temperature of the bio-culture within the bio-reactor tank 30 to achieve the optimum temperature for the replication of the bio-culture. An optimum temperature is generally in the range of between about 70° F. and about 100° F.

The system 10 further comprises a re-circulation pump 60. The re-circulation pump 60 takes a suction from the bottom of the bio-reactor tank 30 via suction line 62, and discharges via re-circ discharge line 64. The re-circ discharge line 64 is coupled to a three way mixing valve 66. The three way mixing valve 66 is controlled by the selection valve control handle 72. Positioning the selection valve control handle 72 controls the proportion of re-circulated bio-culture either returned to the bio-reactor tank 30 via line 68, and/or returned to the contact tank 20 via line 70. The re-circulation pump 60 is controlled by the re-circulation control 88 on the control unit 80. The re-circulation pump 60 is a low pressure pump such as a peristaltic pump. This type of pump, a low pressure pump, is used because the hydraulic pressures internal to a standard centrifugal or positive displacement pump can cause the bio-culture to be injured due to hydraulic shock.

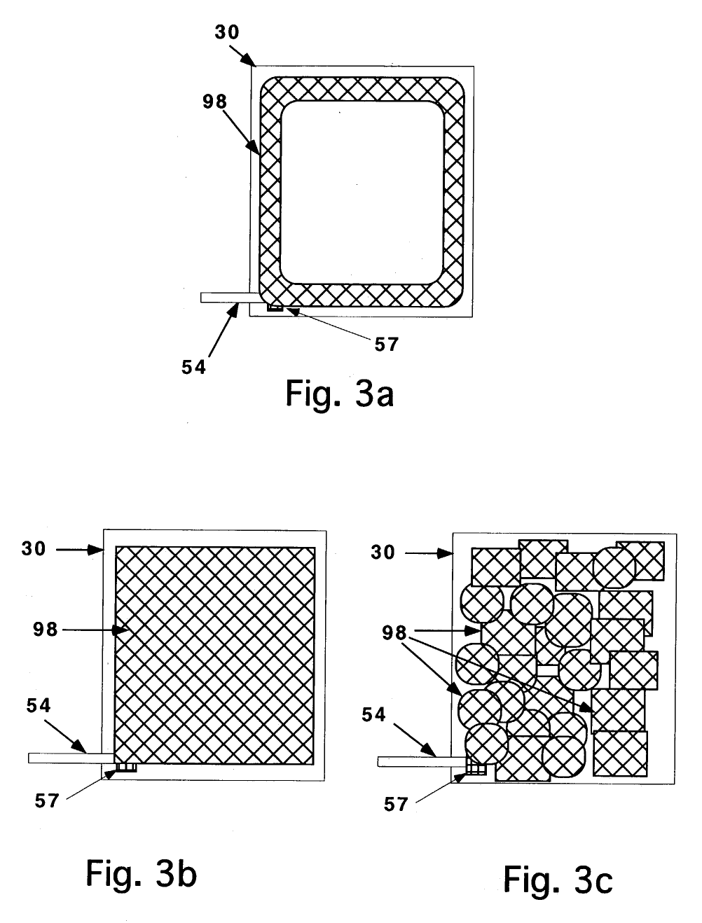

The system 10 further comprises a biological substrate 98, or media 98, located within the bio-reactor tank 30. The media 98 acts as a breeding and shelter area for the microorganisms being propagated within the bio-reactor tank 30. The media can be comprised of any number of materials. Media that have worked include small, extruded plastic floats with large surface areas and polyester fiber mats. Various configurations of reticulated (meaning open cells) carbon-filled or coated polyether foam appears to have both the ideal characteristics of providing adequate space within its open cells, and providing a substrate of a carbonaceous material that acts as a nutrient-bearing surface. One embodiment of the present invention, as shown in FIG. 3a, is to line the inside of the bio-reactor tank 30 with a layer of the media 98. Another embodiment, as shown in FIG. 3b, comprises completely filling the inside of the bio-reactor tank 30 with a solid block of the media 98. Still a third embodiment, as shown in FIG. 3c, is to cut the media 98 into cubes, which will then fill the space inside the bio-reactor tank 30. The media 98 comprises a pore density of 10-40 PPI (pores per inch), although a range of 20-30 is preferable. Additionally, other materials which may provide a suitable media include various porous ceramics, and zeolite.

The system 10 further comprises a delivery system for the bio-culture that has been grown. Although one embodiment comprises a metering pump 40 coupled to the bio-reactor tank 30, additional embodiments of the present invention may comprise: a spigot 42a which may be used to fill a bucket 42b (the spigot 42a and bucket 42b are useful for spot additions of bio-cultures to specific locations of for flushing operations), gravity drip dispensing (not shown), and venturi suction systems. Additionally, although an automatic dispensing system may be proscribed is certain circumstances, such as in a restaurant that needs periodic biological material added to their grease trap, manual additions of produced biological material may be preferable in some circumstances. Furthermore, while it has been found that some wastestreams do better with periodic additions every three hours or so, other applications have better performance and are more economical with batch treatments every 3 days, every week, or even only once a month as may be indicated or desired.

Referring again to FIG. 1, the metering pump 40 takes a suction via suction line 42. The metering pump 40, in a preferred embodiment, is a peristaltic pump to allow precise metering of the bio-culture. The output of the metering pump is via the dispensing outlet 44. The metering pump 40 is controlled by the metering control 92 on the control unit 80. The metering pump 40 is important to the present invention because it is the controlled, and closely measured, addition of the bio-culture to the waste that makes the present invention effective in many applications. Adding small amounts of bio-culture on a frequent basis, as opposed to the bulk, infrequent system of the prior art, creates a more even distribution of the bio-culture throughout the waste system and the waste byproducts. It should be noted that while optimum biological activity occurs in the treated waste at a pH of 6.5 to 7.5, The actual treatment range may occur in a pH range of between 6 and 9. Acidic conditions below pH 3 retard the microorganisms ability to degrade organic matter, as does alkaline conditions approaching pH 11 and above. Furthermore, optimum biological activity typically occurs at temperatures between about 70° F. and about 100° F. In order to enhance the affects of the present invention the user may want to utilize methods, well known in the art, and to the extent practicable in order to control the temperature and pH of the targeted waste or waste system. If the waste under treatment is in a lagoon system, the waste should be maintained, if possible, at an optimum pH above 6.0, though up to approximately pH 9 is acceptable depending on the target waste. The desired pH is achievable by the additions of buffering compounds.

Exposed surface areas within the waste collection system can develop a heavy growth of selected bacteria from application of the bio-culture from the system 10 capable of degrading many types of waste including: fecal wastes including hogs, cows, chickens, etc.; animal or other organic type fats; crop residue. Additionally, certain bio-culture microbes can aid in converting ammonia first into nitrite, and then into nitrate. The microbial action of the bio-culture applied by the system 10 has been demonstrated to reduce ammonia levels by >95% and organic loading by >90.

With reference to FIG. 2, a simplified functional diagram of an alternate embodiment of the present invention, a system for reproducing and dispensing bio-cultures for bio-augmentation is shown. This alternate embodiment of the present invention, comprises, a bio-augmentation system 15 (the “system 15” hereinafter) having similar features as previously shown. This embodiment shows a less complex embodiment that may be desirable due to a smaller cost to produce or where the automatic features are not desired by the user or the application.

The system 15 is comprised of a variety of components whose designed objective is the controlled growth of desired bio-cultures and the controlled and accurate delivery thereof into targeted waste or waste systems. The controlled growth of the present invention is capable of achieving microbial count increases of up to a 1000 fold or more. Referring again to FIG. 2, a bio-reactor tank 30 is shown into which concentrated bio-cultures, or bio-culture starter concentrates may be placed, either in dry or liquid form via the fill opening 32. The bio-reactor tank 30 contains the bio-culture both for controlled growth and storage of bio-cultures, and provides a source system for the dispensing of the bio-culture into waste and waste systems. Additionally, if other liquid or fluids are required to be added to the system 15 to provide replacement fluids or for other purposes, they may also be added via the fill opening 32.

Again, examples where the present invention may be utilized are listed in the previous Table 1. As previously discussed, a feature of this embodiment of the present invention is that because it may be desirable to avoid introducing exotic sub-species of microorganisms into a particular environment, the present invention has the capability of reproducing and growing indigenous microorganisms, or bio-culture, wherever the invention is to be used, without the importation of specific “American” sub-species of microorganisms, or bio-culture. This may be achieved by placing various organic materials containing a variety of indigenous microorganisms within the system 15 where they may be cultured. An illustrative example, in an embodiment of the present invention comprises the following: Because the system 15 produces large quantities of waste-digesting microorganisms in the bio-culture from small amounts of selected microorganisms, a typical starter amount can be one ounce of a blend of spoor-form or live, vegetative microorganisms. Although, it should be noted that a smaller or greater amount of the blend of spoor-form or live, vegetative microorganisms may be used in the system 15 as needs dictate. In addition to the blend of spoor-form or live, vegetative microorganisms, 4-ounces or more of specific nutrient materials are also placed into the system 15. These items are mixed into water inside the bio-reactor tank 30 and with proper environmental conditions over a period of time, usually between 3 and 21 days, large quantities of microorganisms are produced and reared. It has been found in some embodiments that some of the highest growth periods of microorganisms occurs between 3 and 7 days. These can then be dispensed into a wastestream, for rapid and thorough biological treatment.

An additional feature of the present invention is that conditioning of the microorganisms to have greater waste-reducing capabilities against a specific targeted waste, may be accomplished by adding samples of the targeted waste to the system 15, during the reproductive process. The bio-cultures that will be grown and dispensed from a preferred embodiment of the present invention, digest sludge, and inhibit undesirable by-products and malodor.

Referring again to FIG. 2, the base stock, or seed bio-cultures are also replenished in the bio-reactor tank 30 on a periodic basis in order to maintain both sufficient bio-reactor tank 30 quantity levels, and to achieve the then desired mix of specific bio-cultures. A further addition, or as part of the bio-culture source stock, is the addition of nutrients. The addition of nutrients to, or as part of, the bio-cultures is an important part of bio-culture growth.

The bio-cultures introduced into the bio-reactor tank 30 will be replicated by the system 15 using support systems coupled to the bio-reactor tank 30 to achieve an ideal growth environment for the bio-cultures. This ideal growth environment will result in the bio-culture forming an ultra-concentrated biological solution possessing very high Colony Forming Units (CFUs). The addition of this ultra-concentrated biological solution to a wastestream or system has the advantage of counteracting any toxins that can get into the waste systems that might destroy beneficial bacteria, thus causing a reduction in treatment capability of the unaided waste system. Additionally, far larger numbers of the beneficial and desired bacteria of the bio-culture are automatically applied to the waste than could otherwise be applied.

When the ultra-concentrated bio-cultures are placed into an aqueous wastewater system they can soon become the dominant organisms in the system, and bio-convert the organic contaminants into fractions of smaller molecular weight. Ultimately, many compounds will be completely metabolized by the bio-cultures and result in a source of carbon useful for cell growth.

The bio-cultures from the system 15 break the chemical structure from complex forms to simple forms: fatty acids, carbon dioxide and water. The microbes grown within the bio-generator tank 30, and within the wastestream, have an absolute rate of biodegradation of the contaminant. This rate of biodegradation can be accelerated by using multiple inoculations.

An ideal growth environment is achieved by the enhancement of the internal conditions of the bio-reactor tank 30. Coupled to the bio-reactor tank 30 is an aerator pump 50. The aerator pump 50 takes a suction on the atmosphere via a suction 52, and pumps air into the bio-reactor tank 30. A 0.2μ [micron] in-line biological filter 53 is used to prevent airborne bacteria from entering the bio-reactor tank 30. The air is pumped into the bio-reactor tank 30 via the air manifold 54, and bubbles into the bio-culture through an airstone 57. The airstone 57 is of the type commonly found coupled to the air pump system in fish aquariums. The addition of the air is used to oxygenate the bio-culture within the bio-reactor tank 30, in order to invigorate and enhance the reproduction of the bio-culture. Those skilled in the art will recognize that other air dispersion means, such as the air manifold 54 and air holes 56, as shown in FIG. 1 may also be used herein. In this embodiment, the air pump 50 may be of the type that runs continually, in which case its plug 94a is plugged into an AC power source. It should be noted however as previously discussed, that in an alternate embodiment of the system 15, different, or higher voltage sources, or even unconventional electrical sources such as solar cell panels, e.g. in an outhouse application in a remote forest location, might be used to power an embodiment of the system 15. The system 15 also comprises a heater 83 to add heat to the bio-culture. Heat is one of the primary elements of microbial growth. This heat can be comprised of many different types, or sources, from the electromagnetic spectrum. For example: Electromagnetic growth accelerators may comprise: audible sound, ultrasound; magnetic energy; low level radiation; and photogenic accelerators, such as growing lights of optimal spectral qualities are some of the “heat” sources, or heaters, that might be utilized in an alternate embodiment of the present invention.

The heater 83 in this embodiment may also be of a type installed in fish aquariums which has an integral temperature control and an AC plug 94c for connecting to an AC power source. The heater 83 is adjusted using its integral thermostat to control the temperature of the bio-culture within the bio-reactor tank 30 to achieve the optimum temperature for the replication of the bio-culture. An optimum temperature is generally in the range of between about 70° F. and about 100° F.

The system 15 may further comprise a re-circulation pump 60. The re-circulation pump 60 takes a suction from the bottom of the bio-reactor tank 30 via suction line 62, and discharges via re-circ discharge line 64. The re-circulation pump 60 is a low pressure pump such as a peristaltic pump. This type of pump, a low pressure pump, is used because the hydraulic pressures internal to a standard centrifugal or positive displacement pump can cause the bio-culture to be injured due to hydraulic shock. The re-circulation pump comprises an AC plug 94b for connecting to an AC power source.

The system 15 further comprises a biological substrate 98, or media 98, located within the bio-reactor tank 30. The media 98 acts as a breeding and shelter area for the microorganisms being propagated within the bio-reactor tank 30. The media can be comprised of any number of materials. Media that have worked include small, extruded plastic floats with large surface areas and polyester fiber mats. Various configurations of reticulated (meaning open cells) carbon-filled or coated polyether foam appears to have both the ideal characteristics of providing adequate space within its open cells, and providing a substrate of a carbonaceous material that acts as a nutrient-bearing surface. One embodiment of the present invention, as shown in FIG. 3a, is to line the inside of the bio-reactor tank 30 with a layer of the media 98. FIG. 3a depicts this lining from a vertical viewpoint looking down into the bio-reactor tank 30. Another embodiment, as shown in FIG. 3b, comprises completely filling the inside of the bio-reactor tank 30 with a solid block of the media 98. Still a third embodiment, as shown in FIG. 3c, is to cut the media 98 into cubes, or other geometric shapes, which will then be placed into and fill the space inside the bio-reactor tank 30. The media 98 comprises a pore density of 10-40 PPI (pores per inch), although a range of 20-30 may be preferable.

The system 15 further comprises a delivery system for the bio-culture. Although one embodiment may comprise a metering pump 40 coupled to the bio-reactor tank 30, wherein the metering pump 40 further comprises an AC power cord 94d, it may also be preferable for the system 15 to only comprise a spigot 42a which may be used to fill a bucket 42b, other suitable container, or be allowed to gravity feed to the desired wasted. The spigot 42a and bucket 42b are also useful for spot additions of bio-cultures to specific locations of for flushing operations, gravity drip dispensing (not shown), and venturi suction systems.

Referring again to FIG. 2, the metering pump 40 takes a suction via suction line 42. The metering pump 40, in this embodiment, may be a peristaltic pump to allow precise metering of the bio-culture. The output of the metering pump is via the dispensing outlet 44.

It should be noted that the previous discussions in reference to FIG. 1 are equally applicable and incorporated in reference to the alternate embodiment of the present invention shown in FIGS. 2-3d

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1. A system for reproducing and dispensing bio-cultures for bio-augmentation, comprising, in combination:
A bio-reactor tank;
waste-digesting bio-culture additive placed into the bio-reactor tank;
nutrient additive placed into the bio-reactor tank;
a metering pump coupled to the bio-reactor tank;
an aeration pump coupled to the bio-reactor tank; and
a control system coupled to the metering pump and coupled to the aeration pump.

2. The system of claim 1 further comprising a bio-culture contact tank coupled to the bio-reactor tank.

3. The system of claim 1 further comprising a controlled heating element coupled to the bio-reactor tank.

4. The system of claim 3 further comprising a re-circulation pump coupled to the bio-reactor tank.

5. The system of claim 4 further comprising a mixing valve coupled to the bio-culture contact tank, to the bio-reactor tank, and to the re-circulation pump.

6. The system of claim 1 further comprising an in-line biological filter coupled to the aeration pump.

7. The system of claim 6 further comprising a biological substrate situate within the bio-reactor tank.

8. A system for reproducing and dispensing bio-cultures for bio-augmentation, comprising, in combination:
A bio-reactor tank;
A biological substrate situate within the bio-reactor tank
an aeration pump coupled to the bio-reactor tank; and
an in-line biological filter coupled to the aeration pump.

9. The system of claim 8 further comprising a controlled heating element coupled to the bio-reactor tank.

10. The system of claim 9 further comprising a re-circulation pump coupled to the bio-reactor tank.

11. The system of claim 8 further comprising a waste-digesting bio-culture additive placed into the bio-reactor tank.

12. The system of claim 11 further comprising a nutrient additive placed into the bio-reactor tank.

13. The system of claim 8 further comprising a spigot coupled to the bio-reactor tank.

14. The system of claim 8 further comprising a metering pump coupled to the bio-reactor tank.

15. A system for reproducing and dispensing bio-cultures for bio-augmentation, comprising, in combination:
A bio-reactor tank;
waste-digesting bio-culture additive placed into the bio-reactor tank;
nutrient additive placed into the bio-reactor tank; and
an aeration pump coupled to the bio-reactor tank.

16. The system of claim 15 further comprising a heating element coupled to the bio-reactor tank.

17. The system of claim 15 further comprising a re-circulation pump coupled to the bio-reactor tank.

18. The system of claim 15 further comprising an in-line biological filter coupled to the aeration pump.

19. The system of claim 15 further comprising a biological substrate situate within the bio-reactor tank.

20. The system of claim 15 further comprising a means for dispensing coupled to the bio-reactor tank.
